(19) United States
(12) Patent Application Publication
(10) Pub. No.: US 2015/0343604 A1
(43) Pub. Date: Dec. 3, 2015

(54) POLISHING PAD PRODUCTION METHOD

(71) Applicant: TOYO TIRE & RUBBER CO., LTD., Osaka-shi, Osaka (JP)

(72) Inventor: Tsuyoshi KIMURA, Osaka (JP)

(73) Assignee: TOYO TIRE & RUBBER CO., LTD., Osaka-shi, Osaka (JP)

(21) Appl. No.: 14/654,831

(22) PCT Filed: Oct. 18, 2013
(86) PCT No.: PCT/JP2013/078289

§ 371 Date: Jun. 22, 2015

(30) Foreign Application Priority Data
Dec. 28, 2012 (JP) 2012-288521

(51) Int. Cl. B24D 11/00; C08G 18/48; C08G 18/76; C08G 18/73; B24B 37/26; B24B 37/24

(52) U.S. Cl. CPC B24D 11/003; B24B 37/26; B24B 37/24; C08G 18/7621; C08G 18/73; C08G 18/4854; C08G 2101/0008

(57) ABSTRACT

The present invention includes a polishing pad production method comprising a step of forming one or more grooves in a surface of a polishing layer comprising a flexible polyurethane foam, wherein the flexible polyurethane foam has an Asker D hardness of 30 or less at 25° C., and the step comprises a step 1 of cooling the polishing layer to adjust the Asker D hardness of the flexible polyurethane foam to 35 or more, and a step 2 of forming one or more grooves in the surface of the polishing layer comprising the flexible polyurethane foam, the Asker D hardness of which has been adjusted by the cooling. According to the polishing pad production method of the present invention, it is possible to provide a polishing pad production method capable of performing grooving in a polishing layer with a high precision when the polishing layer comprises a flexible polyurethane foam.

### TECHNICAL FIELD

The present invention relates to a polishing pad used at the time of polishing a surface of, for example, optical materials including a lens and a reflecting mirror, a silicon wafer, a substrate of a compound semiconductor such as silicon carbide or sapphire, or a glass substrate or aluminum substrate for a hard disc; and a production method of the pad. The polishing pad of the invention is favorably used, in particular, as a finishing polishing pad.

### BACKGROUND ART

When a semiconductor device is produced, for example, the following steps are performed: the step of forming a conductive film on a surface of a wafer, and subjecting the resultant to photolithography, etching and other processings to form an interconnection layer; and the step of forming an interlayer dielectric onto the interconnection layer. These steps result in the generation of irregularities made of conductor such as metal, or insulator on the wafer surface. In recent years, interconnections have been becoming finer and turning into a higher-level multi-layered form for the purpose of making the integration degree of semiconductor integrated circuits higher. With this tendency, a technique for planarizing irregularities of wafer surfaces has been become important.

As a method for planarizing irregularities of wafer surfaces, adopted is generally a chemical mechanical polishing (hereinafter referred to as CMP) method. CMP is a technique of pushing the surface to be polished of a material to be polished onto a polishing surface of a polishing pad, and using, in this state, a slurry-form polishing agent in which abrasive grains are dispersed (hereinafter referred to as a slurry) to polish the surface to be polished.

When CMP is performed, it is necessary to supply a slurry evenly onto a wafer surface without remaining any specific site of the wafer surface, and further to renew the supplied slurry with a newly supplied slurry. For this purpose, multiple grooves are formed on a polishing surface of a conventionally used polishing pad. Patent Documents 1 and 2 listed below each disclose an apparatus for cutting such grooves, and a method therefor.

### PRIOR ART DOCUMENT

### Patent Documents

Patent Document 1: JP-A-2008-137148
Patent Document 2: JP-A-2008-200767

### SUMMARY OF THE INVENTION

### Problems to be Solved by the Invention

However, in a case where a polishing layer of a polishing pad is made of a flexible polyurethane foam (having an Asker D hardness of 30 or less at normal temperature (25° C.)) (in the case of a finishing polishing pad), conventional conditions cause a problem that grooving cannot be performed with a high precision since “retreat” is generated at the grooving time. Moreover, this results in a problem that the finishing polishing pad is lowered in polishing property.

In light of these problems, the present invention has been made, and an object thereof is to provide a polishing pad production method capable of performing grooving with a high precision when a polishing layer of a polishing pad comprises a flexible polyurethane foam.

### Means for Solving the Problems

The present invention includes a polishing pad production method comprising a step of forming one or more grooves in a surface of a polishing layer comprising a flexible polyurethane foam, wherein the flexible polyurethane foam has an Asker D hardness of 30 or less at 25° C., and the step comprises a step 1 of cooling the polishing layer to adjust the Asker D hardness of the flexible polyurethane foam to 35 or more, and a step 2 of forming one or more grooves in the surface of the polishing layer comprising the flexible polyurethane foam, the Asker D hardness of which has been adjusted by the cooling.

The present invention also includes a grooving method for a polishing pad having one or more grooves in a surface of a polishing layer comprising a flexible polyurethane foam, wherein the flexible polyurethane foam has an Asker D hardness of 30 or less at 25° C., and the grooving method for a polishing pad comprises a step 1 of cooling the polishing layer to adjust the Asker D hardness of the flexible polyurethane foam to 35 or more, and a step 2 of forming one or more grooves in the surface of the polishing layer comprising the flexible polyurethane foam, the Asker D hardness of which has been adjusted by the cooling.

The present invention also includes a polishing pad grooving machine for forming one or more grooves in a surface of a polishing pad, wherein the polishing pad grooving machine comprises a grooving platen, and the grooving platen has a cooling function.

The present invention also includes a polishing pad grooving machine for forming one or more grooves in a surface of a polishing pad, wherein the polishing pad grooving machine comprises cooling means for cooling the inside of the polishing pad grooving machine.

### Effect of the Invention

According to the present invention, grooving is performed in the state of adjusting, to an Asker D hardness of 35 or more, a polishing layer comprising a flexible polyurethane foam the Asker D hardness of which is 30 or less at normal temperature (25° C.); thus, the polishing layer can be prevented from undergoing retreat at the grooving time. It is therefore possible to provide a polishing pad production method capable of performing grooving in a polishing layer with a high precision even when the polishing layer comprises a flexible polyurethane foam having an Asker D hardness of 30 or less at 25° C., and capable of improving a finishing polishing pad in polishing property.

### BRIEF DESCRIPTION OF THE DRAWINGS

FIG. 1 is a schematic structural view illustrating an example of a polishing apparatus used in CMP polishing.

FIG. 2 is a graph showing a relationship between the temperature of a flexible polyurethane foam, and the Asker D hardness thereof.

### MODE FOR CARRYING OUT THE INVENTION

The polishing pad production method of the present embodiment is a polishing pad production method comprising a step of forming one or more grooves in a surface of a polishing layer comprising a flexible polyurethane foam, wherein the flexible polyurethane foam has an Asker D hardness of 30 or less at 25° C., and the step comprises a step 1 of cooling the polishing layer to adjust the Asker D hardness of the flexible polyurethane foam to 35 or more, and a step 2 of forming one or more grooves in the surface of the polishing layer comprising the flexible polyurethane foam, the Asker D hardness of which has been adjusted by the cooling.

### <Flexible Polyurethane Foam>

The flexible polyurethane foam is made from an isocyanate component, an active hydrogen group-containing compound (a high-molecular-weight polyol or an active hydrogen group-containing low-molecular-weight compound), a chain extender, or some other.

As the isocyanate component, such a compound known in the field of polyurethane is usable without any particular limitation. Examples thereof include aromatic diisocyanates such as 2,4-toluene diisocyanate, 2,6-toluene diisocyanate, 2,2′-diphenylmethane diisocyanate, 2,4′-diphenylmethane diisocyanate, 4,4′-diphenylmethane diisocyanate, polymeric MDI, carbodiimide-modified MDI (for example, MILIONATE MTL (trade name) manufactured by Nippon Polyurethane Industry Co., Ltd.), 1,5-naphthalene diisocyanate, p-phenylene diisocyanate, m-phenylene diisocyanate, p-xylylene diisocyanate, and m-xylylene diisocyanate; aliphatic diisocyanates such as ethylene diisocyanate, 2,2,4-trimethylhexamethylene diisocyanate, and 1,6-hexamethylene diisocyanate; and alicyclic diisocyanates such as 1,4-cyclohexane diisocyanate, 4,4′-dicyclohexylmethane diisocyanate, isophorone diisocyanate, and norbornane diisocyanate. These may be used alone, or in any combination of two or more thereof.

Together with the diisocyanate as described above, a polymerized diisocyanate may be used. The polymerized diisocyanate is an isocyanate-modified product that is polymerized by the addition of three or more diisocyanates, or a mixture thereof. Examples of the isocyanate-modified product include 1) trimethylolpropane adduct type, 2) biuret type, and 3) isocyanurate type. The isocyanate-modified product is in particular preferably an isocyanurate type product.

In the present embodiment, it is preferred to use, as the isocyanate component, a polymerized diisocyanate and an aromatic diisocyanate in combination. As a diisocyanate to form the polymerized diisocyanate, an aliphatic diisocyanate is preferably used, and 1,6-hexamethylene diisocyanate is in particular preferably used. Further, urethane-modified, allophanate-modified, and biuret-modified products may be used as the polymerized diisocyanate. The aromatic diisocyanate is preferably toluene diisocyanate.

The polymerized diisocyanate is used in a proportion preferably from 15 to 60% by weight, more preferably from 19 to 55% by weight based on the whole of the isocyanate components.

Examples of the high-molecular-weight polyol include polyether polyols, a typical example thereof being polytetramethylene ether glycol; polyester polyols, a typical example thereof being polybutylene adipate; polyester-polycarbonate polyols, examples thereof including reaction products of a polyester glycol such as polycaprolactone polyol or polycaprolactone, and an alkylene carbonate; polyester-polycarbonate polyols obtained by allowing ethylene carbonate to react with a polyhydric alcohol, and next allowing the resultant reaction mixture to react with an organic dicarboxylic acid; and polycarbonate polyols obtained by a transesterification reaction between a polyhydroxyl compound and an aryl carbonate. These compounds may be used alone or in any combination of two or more thereof.

The number-average molecular weight of the high-molecular-weight polyol is not particularly limited, and is preferably from 500 to 5000 from the viewpoint of elastic properties of the resultant polyurethane resin, and others. If the number-average molecular weight is less than 500, a polyurethane resin obtained by use of this polyol does not have sufficient elastic properties, and thus the resin is a brittle polymer. Consequently, a polishing pad produced from this polyurethane resin is excessively hard, thereby causing a scratch in a wafer surface. On the other hand, if the number-average molecular weight is more than 5000, a polyurethane resin obtained by use of this polyol is too soft so that a polishing pad produced from this polyurethane resin tends to be poor in planarizing property.

Besides the high-molecular-weight polyol, an active hydrogen group-containing low-molecular-weight compound may be used. The active hydrogen group-containing low-molecular-weight compound is a compound having a molecular weight less than 500. Examples thereof include low-molecular-weight polyols such as ethylene glycol, 1,2-propylene glycol, 1,3-propylene glycol, 1,2-butanediol, 1,3-butanediol, 1,4-butanediol, 2,3-butanediol, 1,6-hexanediol, neopentyl glycol, 1,4-cyclohexanedimethanol, 3-methyl-1,5-pentanediol, diethylene glycol, triethylene glycol, 1,4-bis(2-hydroxyethoxy)benzene, trimethylolpropane, glycerin, 1,2,6-hexanetriol, pentaerythritol, tetramethylolcyclohexane, methylglycoside, sorbitol, mannitol, dulcitol, sucrose, 2,2,6,6-tetrakis(hydroxymethyl)cyclohexanol, diethanolamine, N-methyldiethanolamine, and triethanolamine; low-molecular-weight polyamines such as ethylenediamine, tolylenediamine, diphenylmethanediamine, and diethylenetriamine; and alcoholamines such as monoethanolamine, 2-(2-aminoethylamino)ethanol, and monopropanolamine. These active hydrogen group-containing low-molecular-weight compounds may be used alone or in any combination of two or more thereof.

The ratio between the high-molecular-weight polyol and the active hydrogen group-containing low-molecular-weight compound is determined in accordance with properties required for a polishing layer produced from these compounds.

When the polyurethane resin is produced by a prepolymer method, a chain extender is used for curing a prepolymer. The chain extender is an organic compound having at least two or more active hydrogen groups. Examples of the active hydrogen group include a hydroxyl group, a primary or secondary amino group, and a thiol group (SH). Specific examples of the extender include polyamines such as 4,4′-methylenebis(o-chloroaniline) (MOCA), 2,6-dichloro-p-phenylenediamine, 4,4′-methylenebis(2,3-dichloroaniline), 3,5-bis(methylthio)-2,4-toluenediamine, 3,5-bis(methylthio)-2,6-toluenediamine, 3,5-diethyltoluene-2,4-diamine, 3,5-diethyltoluene-2,6-diamine, trimethylene glycol-di-p-aminobenzoate, polytetramethyleneoxide-di-p-aminobenzoate, 4,4′-diamino-3,3′,5,5′-tetramethyldiphenylmethane, 4,4′-diamino-3,3′-diisopropyl-5,5′-dimethyldiphenylmethane, 4,4′-diamino-3,3′,5,5′-tetraisopropyldiphenylmethane, 1,2-bis(2-aminophenylthio)ethane, 4,4′-diamino-3,3′-diethyl-5,5′-dimethyldiphenylmethane, N,N′-di-sec-butyl-4,4′-diaminodiphenylmethane, 3,3′-diethyl-4,4′-diaminodiphenylmethane, m-xylylenediamine, N,N′-di-sec-butyl-p-phenylenediamine, m-phenylenediamine, and p-xylylenediamine; and the low-molecular-weight polyols described above; and the low-molecular-weight polyamines described above. These may be used alone or in the form of a mixture of two or more thereof.

The flexible polyurethane foam may be produced by an application of a known urethanation technique such as a melting method or solution method, using the raw material of the polyurethane resin. The flexible polyurethane foam is produced preferably by a melting method when costs, working environments and others are considered.

The production of the flexible polyurethane foam may be attained by either a prepolymer method or a one shot method. Preferred is a prepolymer method in which an isocyanate-terminated prepolymer is synthesized from an isocyanate component and an active hydrogen group-containing compound in advance, and then a chain extender is allowed to react with this prepolymer since physical properties of the resultant polyurethane resin are excellent.

In the synthesis of the isocyanate-terminated prepolymer, the ratio of the number of isocyanate groups in the isocyanate component to that of active hydrogen groups (hydroxyl groups and amino groups) in the active hydrogen group-containing compound is preferably from 1.5 to 3.0, more preferably from 1.8 to 2.5.

In the synthesis of the isocyanate-terminated prepolymer, the NCO percent by weight is preferably adjusted to from 5 to 8% by weight, more preferably from 5.8 to 8% by weight.

The ratio between the isocyanate-terminated prepolymer and the chain extender may be variously changed depending on each molecular weight and the desired physical properties of the polishing pad. In order to yield a polishing pad having desired polishing properties, the ratio of the number of isocyanate groups of the prepolymer to that of active hydrogen groups (hydroxyl groups and amino groups) of the chain extender is preferably from 0.80 to 1.20, more preferably from 0.99 to 1.15. If the number of isocyanate groups is out of this range, there is a tendency that curing failure occurs, so that the specific gravity and hardness to be required cannot be obtained, leading to a deterioration in polishing properties.

Examples of the method for producing the flexible polyurethane foam include a method of adding hollow beads, a mechanically foaming method (for example, a mechanical frothing method), and a chemically foaming method. The individual methods may be used together. In particular, preferred is a mechanically foaming method using a silicone surfactant, which is a copolymer of a polyalkylsiloxane and a polyether. Examples of a preferred compound as the silicone surfactant include SH-192 and L-5340 (manufactured by Dow Corning Toray Silicone Co., Ltd.), B8443 and B8465 (manufactured by Goldschmidt Chemical Corporation). The silicone surfactant is preferably added at a concentration of from 0.05 to 10% by weight, more preferably from 0.1 to 5% by weight, to the polyurethane-forming raw material composition.

Thereto may be optionally added a stabilizer such as an antioxidant, a lubricant, a pigment, a filler, an antistatic agent, and any other additive.

The following will describe an example of the case of producing a flexible polyurethane foam constituting a polishing layer by the prepolymer method. This method for producing the flexible polyurethane foam has the following steps:

### 1) Foaming Step of Preparing Cell Dispersion Liquid

The step includes adding a silicone surfactant to a first component containing an isocyanate-terminated prepolymer so that the polyurethane resin foam contains 0.05 to 10% by weight of the silicone surfactant and stirring the mixture in the presence of a non-reactive gas to forma cell dispersion liquid in which the non-reactive gas is dispersed in the form of fine cells. In a case where the prepolymer is solid at an ordinary temperature, the prepolymer is preheated to a proper temperature and used in a molten state.

### 2) Curing Agent (Chain Extender) Mixing Step

A second component containing a chain extender is added to the cell dispersion liquid, and these components are mixed with each other. The mixture is then stirred to prepare a foaming reaction liquid.

### 3) Casting Step

The foaming reaction liquid is cast into a mold.

### 4) Curing Step

The foaming reaction liquid having been cast into the mold is heated and subjected to reaction curing.

The non-reactive gas used for forming fine cells is preferably not combustible, and is specifically nitrogen, oxygen, a carbon dioxide gas, a rare gas such as helium or argon, and a mixed gas thereof, and air dried to remove water is most preferable in respect of cost.

As a stirring device for making the non-reactive gas into fine cells to be dispersed into the first component containing the silicone surfactant, a known stirring device is usable without any particular limitation. Specific examples thereof include a homogenizer, a dissolver, and a biaxial planet mixer (planetary mixer). The shape of a stirring blade of the stirring device is not particularly limited. A whipper-type stirring blade is preferably used to form fine cells.

It is also preferable mode to use different stirring devices in stirring for forming a cell dispersion liquid in the foaming step and in stirring for mixing an added chain extender in the mixing step. In particular, stirring in the mixing step may not be stirring for forming cells, and a stirring device not generating large cells is preferably used. Such a stirring device is preferably a planetary mixer. The same stirring device may be used in the foaming step and the mixing step, and stirring conditions such as revolution rate of the stirring blade are preferably regulated as necessary.

In the method for producing the flexible polyurethane foam, heating and post-curing of the foam obtained after casting the foaming reaction liquid into a mold, followed by reaction, until the foaming reaction liquid lost fluidity are effective in improving the physical properties of the foam, and are extremely preferable. It is allowable to use conditions for casting the foaming reaction liquid into a mold and putting the mold immediately into a heating oven to post-cure the liquid. Even under such conditions, heat is not immediately transmitted to the reaction components so that the diameters of the cells do not increase. The curing reaction is conducted preferably at normal pressure since the shape of the cells is stabilized.

In the flexible polyurethane foam, a known catalyst for promoting polyurethane reaction such as a tertiary amine catalyst, may be used. The kind and addition amount of the catalyst are selected, considering a period when the reaction liquid flows into the mold, which has a predetermined shape, after the mixing step.

The production of the flexible polyurethane foam may be in a batch system where each component is weighed, charged into a vessel and stirred, or in a continuous production system where each component and a non-reactive gas are continuously supplied into, and stirred in a stirring apparatus and the cell dispersion liquid is transferred to produce molded articles.

The production of the flexible polyurethane foam may be in a manner of putting, into a reactor, a prepolymer which is a raw material of the flexible polyurethane foam, charging a chain extender thereinto, stirring these components, casting the stirred components into a mold having a predetermined size to produce a block, and then using a slicer like a planer or a band saw to slice the block; or of making, at the stage of the casting, the stirred components into a thin sheet form.

The flexible polyurethane foam has an average cell diameter of preferably from 30 to 100 μm, more preferably from 30 to 80 μm. If the average cell diameter is out of this range, planarity (flatness) of a material to be polished after polishing tends to be reduced.

The flexible polyurethane foam has a specific gravity of preferably from 0.5 to 1.0, more preferably from 0.5 to 0.9, in particular preferably from 0.7 to 0.9.

The flexible polyurethane foam has a hardness of 30 or less at normal temperature (25° C.) according to an Asker D hardness meter. If the Asker D hardness is more than 30, scratches tend to be generated for finishing polishing. The flexible polyurethane foam has a hardness of preferably 25 or more at normal temperature (25° C.) according to an Asker D hardness meter. If the Asker D hardness is less than 25, the resin foam tends to be lowered in planarizing property.

### <Polishing Pad>

The structure of the polishing pad according to the present embodiment is not particularly limited as far as the pad has a polishing layer comprising the flexible polyurethane foam. The polishing pad may be a polishing pad consisting only of the polishing layer, or a polishing pad in which a polishing layer comprising the flexible polyurethane foam is bonded to a cushion sheet (layered polishing pad).

The cushion sheet (cushion layer) is a sheet for compensating for properties of the polishing layer. The cushion sheet is a member necessary for making both of the planarity and uniformity, which have a tradeoff relationship therebetween, compatible with each other in CMP. The planarity denotes the flatness of a patterned portion obtained at the time of polishing a material to be polished having fine irregularities generated when the pattern is formed. The uniformity denotes evenness of the whole of a material to be polished. The planarity is improved in accordance with properties of the polishing layer, and the uniformity is improved in accordance with properties of the cushion sheet. In the polishing pad according to the present embodiment, it is preferred to use, as the cushion sheet, a sheet softer than the polishing layer.

The cushion sheet is, for example, a fiber non-woven fabric such as a polyester non-woven fabric, nylon non-woven fabric or acrylic non-woven fabric; a resin-impregnated non-woven fabric such as a polyester non-woven fabric impregnated with polyurethane; a polymeric resin foam such as a polyurethane foam or polyethylene foam; a rubbery resin such as butadiene rubber or isoprene rubber; or a photosensitive resin.

Means for bonding the polishing layer and the cushion sheet to each other may be, for example, a method in which a double-sided tape is sandwiched between the polishing layer and the cushion sheet, followed by pressing.

The double-sided tape is a tape having an ordinary structure in which adhesive layers are provided, respectively, on both surfaces of a substrate such as a non-woven fabric or a film. Considering the prevention of the permeation of the slurry into the cushion sheet, it is preferred to use a film as the substrate. The composition of the adhesive layer is, for example, that of a rubber-based adhesive or an acrylic-based adhesive. An acrylic-based adhesive is preferred, considering that the content of metal ions is small. The composition of the polishing layer may be different from that of the cushion sheet; thus, it is allowable to make the respective compositions of the individual adhesive layers of the double-side tape different from each other, so that the adhesive strength of each of the layers may be appropriate.

The thickness of the polishing layer is not particularly limited, and is usually from about 0.8 to 4 mm, preferably from 1.0 to 2.5 mm.

### <Step 1 of Cooling Polishing Layer to Adjust Asker D Hardness of Flexible Polyurethane Foam to 35 or More>

In the step 1, the polishing layer is cooled to adjust the Asker D hardness of the flexible polyurethane foam to 35 or more. When the polishing pad consists only of a polishing layer and when the polishing pad is a layered polishing pad, the whole of the polishing pad is cooled to adjust the Asker D hardness of the flexible polyurethane foam related to the polishing layer to 35 or more in order to make the grooving precision better.

The means for cooling the polishing layer is not particularly limited as far as the means can cool the whole of the polishing layer. An example of the means for cooling the polishing layer includes means of putting the polishing layer or the polishing pad into a refrigerator or a freezer. The cooling means may be set inside a polishing pad grooving machine, and the grooving may be performed in the state of cooling the polishing layer. The cooling means inside the polishing pad grooving machine may be means of supplying cooling air or means of fitting a cooling function (such as a chiller) to a grooving machine platen. The whole of a room for the grooving may be cooled.

The cooling temperature is not particularly limited as far as the cooling makes it possible to adjust, to an Asker D hardness of 35 or more, the flexible polyurethane foam having an Asker D hardness of 30 or less at normal temperature (25° C.) The temperature is, for example, 20° C. or lower. The lower limit of the cooling temperature is not particularly limited, but is preferably 10° C. or higher.

<Step 2 of Forming One or More Grooves in Surface of Polishing Layer Comprising Flexible Polyurethane Foam, Asker D Hardness of which has been Adjusted by Cooling>

In the step 2, one or more grooves are formed in a surface of the polishing layer comprising the flexible polyurethane foam, the Asker D hardness of which has been adjusted by the cooling in the step 1. Examples of the method for forming one or more grooves in the surface of the polishing layer include, but are not particularly limited to, a method of mechanically cutting the surface by using a jig such as a bite having a predetermined size, and a method of fixing, onto a platen, a polishing pad to be grooved, and then allowing a multi-edge unit to invade the workpiece in the state of rotating the platen, thereby performing concentric grooving, the unit being a unit in which edges are arranged at a determined pitch. Even when the method is any method, one or more grooves are formed in the polishing layer in the state that the Asker D hardness has been adjusted by the cooling.

The one or more grooves to be formed are not particularly limited as far as the one or more grooves have a shape permitting the slurry to be held/renewed. Examples thereof include XY-lattice grooves, concentric grooves, a spiral groove, eccentric grooves, radial grooves, and any combination of two or more of these groove species. The structure of convex portions and concave portions of these grooves is generally a structure having regularity. However, in order to make the slurry holding/renewing performance desirable, the groove pitch, the groove width, the groove depth and others may be changed in accordance with individual ranges of the convex and concave structure.

In the polishing pad of the present embodiment, a double-sided tape may be provided on the surface thereof adhered to a platen. As the double-sided tape, a tape having a common structure can be used in which adhesive layers are, as described above, provided on both surfaces of a substrate. Examples of the substrate include a non-woven fabric and a film. Considering the peeling of the polishing pad from the platen after the pad is used, it is preferred to use a film as the substrate. As the composition of an adhesive layer, for example, a rubber-based adhesive or an acrylic-based adhesive is used. An acrylic-based adhesive is preferred, considering that the content of metal ions is small.

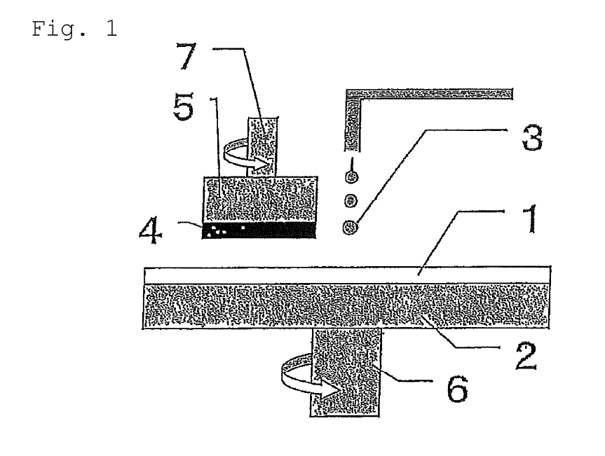

A semiconductor device is produced through the step of using the polishing pad to polish a surface of a semiconductor wafer. The semiconductor wafer is generally a member in which an interconnection metal and an oxide film are laminated onto a silicon wafer. The method and device for polishing the semiconductor wafer are not particularly limited. As illustrated in FIG. 1, the method is performed by use of, for example, a polishing apparatus equipped with a polishing platen 2 supporting a polishing pad (a polishing layer) 1, a support (polishing head) 5 holding a semiconductor wafer 4, a backing material for applying uniform pressure against the wafer and a supply mechanism of a polishing agent 3. The polishing pad 1 is mounted on the polishing platen 2 by attaching the pad to the platen with a double sided tape. The polishing platen 2 and the support 5 are disposed so that the polishing pad 1 and the semiconductor wafer 4 supported or held by the polishing platen 2 and the support 5, respectively, are opposite to each other. The polishing platen 2 and the support 5 are provided with respective rotary shafts 6 and 7. A pressure mechanism for pressing the semiconductor wafer 4 to the polishing pad 1 is installed on the support 5 side. During polishing, the semiconductor wafer 4 is polished by being pressed against the polishing pad 1 while the polishing platen 2 and the support 5 are rotated and a slurry is fed. A flow rate of the slurry, a polishing load, a polishing platen rotation number and a wafer rotation number are not particularly limited, and they are properly adjusted.

Through this process, projected portions on the surface of the semiconductor wafer 4 are removed so that the surface is polished flatly. Thereafter, the wafer is subjected to dicing, bonding, packaging and other operations. In this way, a semiconductor device is produced. The semiconductor device is used for an arithmetic processing unit, a memory, and others.

### EXAMPLES

Hereinafter, the present invention will be described by way of examples. However, the present invention is not limited to these examples.

### [Measuring and Evaluating Methods]

### (Number-Average Molecular Weight)

A number-average molecular weight was measured by GPC (gel permeation chromatography) and a value as measured was converted in terms of standard polystyrene.

GPC device: LC-10A, manufactured by SHIMADZU CORPORATION.

Columns: the following three columns connected to each other are used: column (PLgel, 5 μm, 500 angstroms), column (PLgel, 5 μm, 100 angstroms), and column (PLgel, 5 μm, 50 angstroms) each manufactured by Polymer Laboratories Inc.

Flow rate: 1.0 mL/min.

Concentration: 1.0 g/L

Injected amount: 40 μL

Column temperature: 40° C.

Eluent: tetrahydrofuran

### (Average Cell Diameter)

A prepared polyurethane foam was cut with a microtome cutter to have parallel surfaces and to be made as thin as possible to give a thickness of 1 mm or less. The cut foam was used as a sample for measuring average cell diameter. The sample was fixed on a slide glass piece, and an SEM (S-3500N, manufactured by Hitachi Science Systems Ltd.) was used to observe the sample with 100 magnifications. In the resultant image, an image analyzing software (WinRoof, manufactured by Mitani Corp.) was used to measure the respective diameters of all cells in an arbitrary range of the image. The average cell diameter thereof was calculated.

### (Specific Gravity)

Measurement was conducted in accordance with JIS Z8807-1976. A prepared polyurethane foam was cut out into a rectangular form 4 cm×8.5 cm in size (thickness: arbitrary). The resultant cut foam was used as a sample for measuring specific gravity. The sample was allowed to stand still in an environment having a temperature of 25° C. and a humidity of 50±5% for 16 hours. The specific gravity was measured, using a gravimeter (manufactured by Sartorius Co., Ltd.).

### (D Hardness of Polishing Surface of Flexible Polyurethane Foam)

Measurement was conducted in accordance with JIS K6253-1997. A prepared polyurethane foam was cut out into a piece having a size of 2 cm×2 cm (thickness: arbitrary). The resultant piece was used as a sample for measuring hardness. The sample was allowed to stand still in an environment having a temperature of 25° C. and a humidity of 50±5%, as conditions at normal temperature, for 16 hours. At the time of cooling, the same sample as described above was stored in the same temperature-keeping tank as cooling-temperature conditions for 30 minutes or more. In the hardness measurement, samples were stuck on one another to a thickness of 6 mm or more. A hardness meter (Asker D hardness meter, manufactured by Kobunshi Keiki Co., Ltd.) was used to measure hardness.

### (Grooving Evaluation)

Regarding a single polishing sheet, the respective thicknesses of 20 in-plane positions thereof were measured. The difference between the maximum value and minimum value thereof was calculated to determine the variance of the in-plane thicknesses of the polishing sheet. Regarding a plurality of polishing sheets yielded by slicing operations in each of the examples, the respective in-plane thickness variances of the sheets were averaged to determine the average in-plane thickness variance of the polishing sheets. A criterion for evaluation is as follows:

◯: groove cross sections are each in a rectangular form, and the groove dimensions are as have been designed.

Δ: groove cross sections are slightly out of shape, and the groove dimensions are near the lower limit.

X: groove cross sections are out of shape, and the groove dimensions are out of the specified range.

### (Polishing Property Evaluation)

A polishing apparatus, SPP600S (manufactured by Okamoto Machine Tool Works, Ltd.) was used. A prepared polishing pad was used to evaluate the polishing property thereof. In order to calculate the polishing rate, a thermally oxidized film was formed into a thickness of 1 μm onto an 8-inch silicon wafer, and the resultant was polished for 60 seconds. From the polish amount generated at this polishing time, the polishing rate was calculated. The film thickness of the oxidized film was measured, using an optically interferometric thickness meter (Nanospec, manufactured by Nanometrics Inc.). Conditions for the polishing were as follows: while the wafer was polished, a silica slurry (SS12, manufactured by Cabot) was added as a slurry at a flow rate of 150 mL/min. The polishing load, the rotation number of the polishing platen, and that of the wafer were set to 350 g/cm², 35 rpm, and 30 rpm, respectively. For initial dressing, a dresser (M type #100, manufactured by Asahi Diamond Industrial Co., Ltd.) was used to subject the front surface of the polishing pad to dressing treatment for 30 minutes. About conditions for the dressing, the dressing load, the rotation number of the polishing platen, and that of the dresser were set to 10 g/cm², 30 rpm, and 15 rpm, respectively. Thereafter, several dummy wafers were polished; and then a monitoring wafer was polished, and the polishing rate at this time was defined as the initial polishing rate. Individual dressing operations between polishing operations were carried out under the same dressing conditions to be each continued for 20 seconds. While wafers are exchanged, the polishing was continued over 24 hours.

◯: a decline in the polishing rate is within 10%.

X: a decline in the polishing is more than 10%.

### Example 1

### Formation of Polishing Layer

Into a vessel were put 18.2 parts by weight of toluene diisocyanate (TDI-80, manufactured by Mitsui Chemicals, Inc.: 2,4-diisocyanate/2,6-diisocyanate=80/20), 22.5 parts by weight of polymerized 1,6-hexamethylene diisocyanate (SUMIDULE N3300, isocyanurate type, manufactured by Sumika Bayer Urethane Co., Ltd.), 57.1 parts by weight of polytetramethylene ether glycol (PTMG1000, manufactured by Mitsubishi Chemical Corporation; hydroxyl value: 112.2 KOHmg/g), and 2.2 parts by weight of 1,4-butanediol (1,4-BG, manufactured by Nacalai Tesque, Inc.), and the mixture was allowed to react at 70° C. for 4 hours to yield an isocyanate terminated prepolymer A. The content of the polymerized 1,6-hexamethylene diisocyanate is 55% by weight based on the total isocyanate components. To a polymerizing vessel were added 100 parts by weight of the prepolymer A and 3 parts by weight of a silicone surfactant (B8465, manufactured by Goldschmidt), and then these components were mixed with each other. The mixture was adjusted to 80° C. and was defoamed under reduced pressure. Subsequently, the reaction system was vigorously stirred for about 4 minutes with a stirring blade at a rotational speed of 900 rpm so that air bubbles were incorporated into the reaction system. Thereto were added 19.9 parts by weight of 4,4′-methylenebis(o-chloroaniline), which was beforehand melted to have a temperature of 120° C. This mixed liquid was stirred for 1 minute, and then cast into a pan-shaped open mold (casting vessel). The mold was put into an oven when the fluidity of this mixed liquid was lost. The resultant resin was post-cured at 100° C. for 16 hours to yield a flexible polyurethane foam block.

A slicer (VGW-125, manufactured by Amitec Corporation) was used to slice the flexible polyurethane foam block, the temperature of which was kept at about 20° C., so that a polyurethane resin foam sheet was yielded. Next, a buffing machine (manufactured by Amitec Corporation) was used to subject the sheet to surface-buffing treatment until the sheet had a thickness of 1.27 mm. In this way, a polishing sheet (polishing layer) which was adjusted in thickness precision was yielded.

### (Asker D Hardness Adjustment by Cooling)

The polishing sheets were put into thermostats the temperatures of which were set to respective temperatures. After the temperatures of the polishing sheets reached the respective set temperatures, the sheets were cooled for 30 minutes. The polishing layers continued to be put in the thermostats just before grooving was performed.

### (Relationship Between Cooling Temperature and Asker D Hardness)

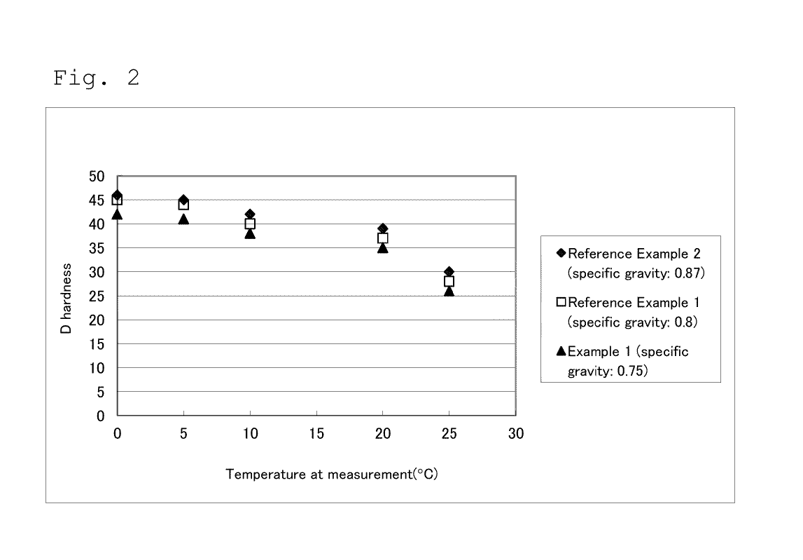

FIG. 2 is a graph showing a relationship between the temperature of the polishing sheet according to Example 1 and the hardness thereof. FIG. 2 also shows a relationship between the temperature of a polishing sheet according to each of Reference Examples 1 and 2 and the hardness thereof, the reference examples being each an example produced in the same way as used to produce the polishing sheet according to Example 1 except that the specific gravity of the sheet was changed to a specific gravity described in FIG. 2. From the graph in FIG. 2, it is understood that the flexible polyurethane foam as described above that has a specific gravity of from 0.75 to 0.9 and an Asker D hardness of 30 or less at normal temperature (25° C.) can be adjusted to an Asker D hardness of 35 or more by cooling the foam to 20° C. or lower.

### (Grooving)

The prepared polishing sheet was stored in an atmosphere of 10° C. for 30 minutes, and then a grooving machine (manufactured by Techno Inc.) was used to form grooves in the polishing sheet so as to each have a groove width of 0.25 mm, a depth of 0.45 mm, and a groove pitch of 1.5 mm.

### (Polishing Layer Preparation)

A laminator was used to bond a double-sided tape (double tack tape, manufactured by Sekisui Chemical Co., Ltd.) to a surface of the polishing sheet that was opposite to the grooved surface thereof. Furthermore, a corona-treated cushion sheet (polyethylene foam, TORAY PEF, manufactured by Toray Industries, Inc.; thickness: 0.8 mm) was prepared. The front surface thereof was subjected to buffing treatment. The laminator was used to bond this cushion sheet onto the double-sided tape. Furthermore, the laminator was used to bond a double-sided tape onto the other surface of the cushion sheet to prepare a polishing pad.

### Example 2 and Comparative Example 1

Polishing pads were produced in the same manner as in Example 1 except that the conditions described in Table 1 were used.

TABLE 1

| | | Exam- | Exam- | Comparative |
|---|---|---|---|---|
| | | ple 1 | ple 2 | Example 1 |
| Prepolymer | PTMG1000 (parts by | 57.1 | 57.1 | 57.1 |
| | weight) | | | |
| synthesis | 1,4-BG (parts by weight) | 2.2 | 2.2 | 2.2 |
| | TDI-80 (parts by weight) | 18.2 | 18.2 | 18.2 |
| | SUMIDULE N3300 | 22.5 | 22.5 | 22.5 |
| | (parts by weight) | | | |
| | Content (% by weight) of | 55 | 55 | 55 |
| | polymerized diisocyanate | | | |
| | based on total isocyanate | | | |
| | components | | | |
| | Index [NCO]/[OH] | 2.00 | 2.00 | 2.00 |
| | NCO wt % | 6.85 | 6.85 | 6.85 |

| | | | |
|---|---|---|---|
| Prepolymer (parts by weight) | 100 | 100 | 100 |
| MOCA (parts by weight) | 19.9 | 19.9 | 19.9 |
| B8465 (parts by weight) | 3 | 3 | 3 |
| Resin foam specific gravity | 0.75 | 0.75 | 0.75 |
| D hardness of flexible polyurethane | 26 | 26 | 26 |
| foam block at 25° C. | | | |
| D hardness of hardness-adjusted | 38 | 35 | 26 |
| flexible polyurethane foam block | | | |
| Temperature (° C.) at D hardness | 10 | 20 | 25 |
| adjusting time | | | |
| Groove shape | ◯ | ◯ | Δ |
| Initial polishing rate | 1653 | 1623 | 1587 |
| Polishing rate after 24 hours | 1625 | 1605 | 1083 |
| Polishing property | ◯ | ◯ | X |

From Table 1, it is understood that in the respective polishing pad production methods of Examples 1 and 2, grooving can be performed with a high precision in their polishing layer made of the flexible polyurethane foam. Since the respective polishing pad production methods of Examples 1 and 2 make it possible to perform the grooving highly precisely in their polishing layer made of the flexible polyurethane foam, it is understood that a finishing polishing pad having such a polishing layer can be restrained from being lowered in polishing property.

### INDUSTRIAL APPLICABILITY

The polishing pad production method of the present invention is usable as a method for producing a polishing pad which is for planarizing optical materials including a lens and a reflecting mirror, a silicon wafer, a glass substrate or aluminum substrate for a hard disc, and which is for attaining an ordinary metal polishing, or any other planarization of a material for which a high-level surface planarity is required.

### DESCRIPTION OF REFERENCE SIGNS

1: polishing pad
2: polishing platen
3: polishing agent (slurry)
4: a material to be polished (semiconductor wafer)
5: support (polishing head)
6 and 7: rotary axes

1. A polishing pad production method, comprising a step of forming one or more grooves in a surface of a polishing layer comprising a flexible polyurethane foam,
wherein the flexible polyurethane foam has an Asker D hardness of 30 or less at 25° C., and
the step comprises a step 1 of cooling the polishing layer to adjust the Asker D hardness of the flexible polyurethane foam to 35 or more, and
a step 2 of forming one or more grooves in the surface of the polishing layer comprising the flexible polyurethane foam, the Asker D hardness of which has been adjusted by the cooling.

2. The polishing pad production method according to claim 1, wherein in the step 1, the cooled polishing layer has a temperature of 20° C. or lower.

3. A grooving method for a polishing pad having one or more grooves in a surface of a polishing layer comprising a flexible polyurethane foam,
wherein the flexible polyurethane foam has an Asker D hardness of 30 or less at 25° C.,
the grooving method for a polishing pad comprises a step 1 of cooling the polishing layer to adjust the Asker D hardness of the flexible polyurethane foam to 35 or more, and
a step 2 of forming one or more grooves in the surface of the polishing layer comprising the flexible polyurethane foam, the Asker D hardness of which has been adjusted by the cooling.

4. The grooving method for a polishing pad according to claim 3, wherein in the step 2, the cooled polishing layer has a temperature of 20° C. or lower.

5. A polishing pad grooving machine for forming one or more grooves in a surface of a polishing pad,
wherein the polishing pad grooving machine comprises a grooving platen, and
the grooving platen has a cooling function.

6. A polishing pad grooving machine for forming one or more grooves in a surface of a polishing pad,
wherein the polishing pad grooving machine comprises cooling means for cooling the inside of the polishing pad grooving machine.
